(19) United States
(12) Patent Application Publication
(10) Pub. No.: US 2004/0137291 A1
(43) Pub. Date: Jul. 15, 2004

(54) Self-controlling fuel cell-power system

(76) Inventors: Stuart I. Smedley, Escondido, CA (US); Donald James Novkov, Encinitas, CA (US); Ethan T. Alger, Oceanside, CA (US); Stephen R. Des Jardins, Encinitas, CA (US); Rajagopalan Sundar, San Diego, CA (US)

Correspondence Address: HOWREY SIMON ARNOLD & WHITE, LLP - OC, 301 RAVENSWOOD AVENUE, BOX 34, MENLO PARK, CA, 94025, US

(21) Appl. No.: 10/661,409

(22) Filed: Sep. 12, 2003

Related U.S. Application Data
(60) Provisional application No. 60/410,391, filed on Sep. 12, 2002.
(60) Provisional application No. 60/410,427, filed on Sep. 12, 2002.
(60) Provisional application No. 60/410,560, filed on Sep. 12, 2002.

(51) Int. Cl. H01M 8/04

(52) U.S. Cl. 429/22; 429/23; 429/13

(57) ABSTRACT

A self-controlling fuel cell power system comprises a fuel cell subsystem having a plurality of possible operating states and a controller which transitions the subsystem among the states. A related method comprises sensing one or more subsystem parameters, and, responsive thereto, transitioning the subsystem among the operating states.

This application claims the benefit of U.S. Provisional Application No. 60/410,391 filed Sep. 12, 2002, U.S. Provisional Application No. 60/410,427 filed Sep. 12, 2002, and U.S. Provisional Application No. 60/410,560 filed Sep. 12, 2002, each of which is hereby fully incorporated by reference herein as though set forth in full.

### BACKGROUND OF THE INVENTION

1. Field of the Invention

This invention relates generally to the operation of fuel cells, and more specifically, to a regenerative fuel cell power system capable of transitioning a fuel cell subsystem among a plurality of operating states according to a self-controlling process.

2. Related Art

Fuel cells are among the more promising technologies for providing a reliable form of alternative energy. One type of fuel cell system is a metal/air fuel cell, which utilizes an electrolyte as a transport medium to carry fuel in the form of metal particles into a cell where the particles react with oxygen. The reaction produces free electrons for generating electricity, and reaction products that include oxide forms of the metal. The metal oxides may be recirculated to another location where metal particles may be recovered from the electrolyte by a separate process. The recovered particles may then be used to recharge the system. Because metal particle fuel cells are rechargeable, they are a renewable power source potentially well-suited for a wide variety of applications including uninterruptible power supplies (UPS), portable power supplies, hybrid vehicle technology, and other end uses that require long-term power storage, or a regenerative or renewable source of electricity. For additional information on metal/air fuel cells, the reader is referred to the following patents, which disclose a particular embodiment of a metal/air fuel cell in which the metal is zinc: U.S. Pat. Nos. 5,952,117; 6,153,328; 6,162,555; 6,296,958; 6,432,292; and 6,522,955; each of which is incorporated by reference herein as though set forth in full.

Currently, operation of fuel cell systems is largely manual. The operation of metal/air fuel cell power delivery and regeneration cycles, if automated, could make this technology a more viable, safer, and attractive form of alternative energy. Therefore, what is needed is a more integrated and automated fuel cell power system as compared to the prior art.

### SUMMARY

A self-controlling fuel cell power system comprises a controller, one or more sensors, and a fuel cell subsystem having one or more fuel cells and a plurality of possible operating states. A method of operating the power system comprises sensing one or more parameters of the fuel cell subsystem and transitioning the subsystem among one or more of the operating states. In one embodiment, examples of the one or more parameters include fuel level, presence of a maintenance demand, and presence of a power demand; and examples of the operating states include Idle, Flush, Discharge, and Regenerate states. In one embodiment, at start-up, the system initializes and operates the subsystem in an Idle state. In this embodiment, with the subsystem in Idle, the system, by means of the one or more sensors, continually senses the one or more parameters, and where there is sufficient fuel, no maintenance demand, and no power demand, the subsystem remains in the Idle state. Depending on the sensed values and on the current operating state, the subsystem in this embodiment may transition to a Flush, Regenerate, or Discharge state, in which case the state transitioned to becomes the current operating state. In one embodiment, when the current operating state is Idle, upon sensing a maintenance demand, the subsystem may transition to the Flush state; upon sensing a low fuel level, the subsystem transitions to the Regenerate state; and upon sensing that power is demanded from the fuel cells, the subsystem transitions to the Discharge state. A maintenance demand may be generated periodically, or in another embodiment, it may be generated as a condition of sensing a low fuel cell voltage. In another embodiment, the subsystem transitions as follows: when the current state is Flush, the subsystem may transition to the Idle state upon sensing a power demand or after completion of a flushing process, or the subsystem may transition to a Regenerate state upon sensing a low fuel level; when the current state is Regenerate, the subsystem may transition to the Idle state upon sensing a high fuel level or a power demand; and when the current state is Discharge, the subsystem may transition to the Flush state upon sensing low fuel, or upon sensing no power demand.

In other embodiments, the method may comprise additional steps for controlling subsystem operation in each of the operating states. In one implementation, controlling the subsystem in the Regenerate state comprises sensing a low fuel level, transporting spent fuel to a regeneration unit, recovering fuel through an electrolysis process, and transporting the recovered fuel back to the fuel cells. In another implementation, controlling the subsystem in the Discharge state comprises sensing a power demand, developing a voltage across the cells by expending fuel responsive to the demand, and delivering power from the fuel cells to meet the demand. Other embodiments comprise additional steps for operating the subsystem in the Discharge state in order to control fuel cell temperature, facilitate cold start-up, and mitigate subsystem failures such as fault currents in fuel cells.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The components in the figures are not necessarily to scale, emphasis instead being placed upon illustrating the principles of the invention. In the figures, like reference numerals designate corresponding parts throughout the different views.

FIG. 1 is a block diagram of one embodiment of a fuel cell power system.

FIG. 2 is a block diagram of one embodiment of a metal particle fuel cell power system.

FIG. 3 is a block diagram of an embodiment of a self-controlling fuel cell power system according to the invention.

FIG. 4a is one embodiment of a method for operating a self-controlling fuel cell power system according to the invention.

FIG. 4b is another embodiment of a method for operating a self-controlling fuel cell power system according to the invention.

FIG. 5 is a state diagram illustrating various operating states of one embodiment of a fuel cell subsystem, and paths for transitioning between the operating states.

FIG. 6 is a process flow diagram illustrating one embodiment of a method according to the invention for transitioning a fuel cell subsystem between operating states.

FIG. 7 illustrates one embodiment of a method according to the invention for a self-controlling fuel cell power system to operate a fuel cell subsystem in a Flush state.

FIG. 8 illustrates one embodiment of a method according to the invention for a self-controlling fuel cell power system to operate a fuel cell subsystem in a Regenerate state.

FIG. 9 illustrates one embodiment of a method according to the invention for a self-controlling fuel cell power system to operate a fuel cell subsystem in a Discharge state.

FIG. 10 illustrates one embodiment of a cold start method for a self-controlling fuel cell power system to operate a fuel cell subsystem in a Discharge state.

FIGS. 11a-11d illustrate embodiments of methods according to the invention for a self-controlling fuel cell power system to reduce shorting currents in a fuel cell subsystem in a Discharge state.

### DETAILED DESCRIPTION

Background on Regenerative Fuel Cells

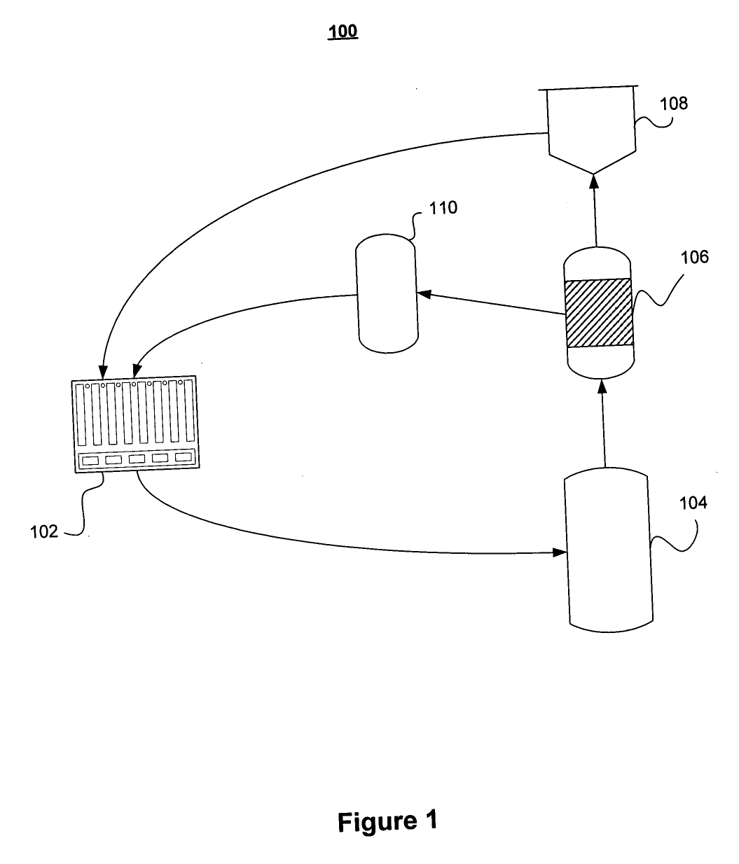

A block diagram of one embodiment of a fuel cell system 100 is illustrated in FIG. 1. As illustrated, the system comprises a power source 102, an optional reaction product storage unit 104, an optional regeneration unit 106, a fuel storage unit 108, an optional second reactant storage unit 110. The power source 102 in turn comprises one or more cells each having a cell body defining a cell cavity, with an anode and cathode situated in each cell cavity. The cells can be coupled in parallel or series. In one implementation, they are coupled in series to form a cell stack.

The anodes within the cell cavities in power source 102 comprise the fuel stored in fuel storage unit 108. Within the cell cavities of power source 102, an electrochemical reaction takes place whereby the anode releases electrons, and forms one or more reaction products. Through this process, the anodes are gradually consumed.

The released electrons flow through a load to the cathode, where they react with one or more second reactants from an optional second reactant storage unit 110 or from some other source. This flow of electrons through the load gives rise to an overpotential (i.e., work) required to drive the demanded current, which overpotential acts to decrease the theoretical voltage between the anode and the cathode. This theoretical voltage arises due to the difference in electrochemical potential between the anode (Zn potential of −1.215V versus SHE (standard hydrogen electrode) reference at open circuit) and cathode (O₂ potential of +0.401V versus SHE reference at open circuit). When the cells are combined in series, the sum of the voltages for the cells forms the output of the power source.

The one or more reaction products can then be provided to optional reaction product storage unit 104 or to some other destination. The one or more reaction products, from unit 104 or some other source, can then be provided to optional regeneration unit 106, which regenerates fuel and/or one or more of the second reactants from the one or more reaction products. The regenerated fuel can then be provided to fuel storage unit 108, and/or the regenerated one or more second reactants can then be provided to optional second reactant storage unit 110 or to some other destination. As an alternative to regenerating the fuel from the reaction product using the optional regeneration unit 106, the fuel can be inserted into the system from an external source and the reaction product can be withdrawn from the system.

The optional reaction product storage unit 104 comprises a unit that can store the reaction product. Exemplary reaction product storage units include without limitation one or more tanks, one or more sponges, one or more containers, one or more vats, one or more barrels, one or more vessels, and the like, and suitable combinations of any two or more thereof. Optionally, the optional reaction product storage unit 104 is detachably attached to the system.

The optional regeneration unit 106 comprises a unit that can electrolyze the reaction product(s) back into fuel (e.g., hydrogen, metal particles and/or metal-coated particles, and the like) and/or second reactant (e.g., air, oxygen, hydrogen peroxide, other oxidizing agents, and the like, and suitable combinations of any two or more thereof). Exemplary regeneration units include without limitation water electrolyzers (which regenerate an exemplary second reactant (oxygen) and/or fuel (hydrogen) by electrolyzing water), metal (e.g., zinc) electrolyzers (which regenerate a fuel (e.g., zinc) and a second reactant (e.g., oxygen) by electrolyzing a reaction product (e.g., zinc oxide (ZnO)), and the like. Exemplary metal electrolyzers include without limitation fluidized bed electrolyzers, spouted bed electrolyzers, and the like, and suitable combinations of two or more thereof. The power source 102 can optionally function as the optional regeneration unit 106 by operating in reverse, thereby foregoing the need for a regeneration unit 106 separate from the power source 102. Optionally, the optional regeneration unit 106 is detachably attached to the system.

The fuel storage unit 108 comprises a unit that can store the fuel (e.g., for metal fuel cells, metal (or metal-coated) particles or liquid born metal (or metal-coated) particles or suitable combinations thereof; for hydrogen fuel cells, hydrogen or hydrogen containing compounds that can be reformed into a usable fuel prior to consumption). Exemplary fuel storage units include without limitation one or more tanks (for example, without limitation, a high-pressure tank for gaseous fuel (e.g., hydrogen gas), a cryogenic tank for liquid fuel which is a gas at operating temperature (e.g., room temperature) (e.g., liquid hydrogen), a metal-hydride-filled tank for holding hydrogen, a carbon-nanotube-filled tank for storing hydrogen, a non-reactive material, e.g., stainless steel, plastic, or the like, tank for holding potassium hydroxide (KOH) and metal (e.g., zinc (Zn), other metals, and the like) particles, a tank for liquid fuel, e.g., and alcohol and the like, one or more sponges, one or more containers (e.g., a plastic container for holding dry metal (e.g., zinc (Zn), other metals, and the like) particles, and the like), one or more vats, one or more barrels, one or more vessels, and the like, and suitable combinations of any two or more thereof. Optionally, the fuel storage unit 108 is detachably attached to the system.

The optional second reactant storage unit 110 comprises a unit that can store the second reactant. Exemplary second reactant storage units include without limitation one or more tanks (for example, without limitation, a high-pressure tank for gaseous second reactant (e.g., oxygen gas), a cryogenic tank for liquid second reactant (e.g., liquid oxygen) which is a gas at operating temperature (e.g., room temperature), a tank for a second reactant which is a liquid or solid at operating temperature (e.g., room temperature), and the like), one or more sponges, one or more containers, one or more vats, one or more barrels, one or more vessels, and the like, and suitable combinations of any two or more thereof. Optionally, the optional second reactant storage unit 110 is detachably attached to the system.

In one embodiment, the fuel cell utilized in the practice of the invention system is a metal fuel cell. The fuel of a metal fuel cell is a metal that can be in a form to facilitate entry into the cell cavities of the power source 102. For example, the fuel can be in the form of metal (or metal-coated) particles or liquid born metal (or metal-coated) particles or suitable combinations thereof. Exemplary metals for the metal (or metal-coated) particles include without limitation zinc, aluminum, lithium, magnesium, iron, and the like.

In this embodiment, when the fuel is optionally already present in the anode of the cell cavities in power source 102 prior to activating the fuel cell, the fuel cell is pre-charged, and can start-up significantly faster than when there is no fuel in the cell cavities and/or can run for a time in the range(s) from about 0.001 minutes to about 100 minutes without additional fuel being moved into the cell cavities. The amount of time which the fuel cell can run on a pre-charge of fuel within the cell cavities can vary with, among other factors, the pressurization of the fuel within the cell cavities, and alternative embodiments of this aspect of the invention permit such amount of time to be in the range(s) from about 1 second to about 100 minutes or more, and in the range(s) from about 30 seconds to about 100 minutes or more.

Moreover, the second reactant optionally can be present in the fuel cell and pre-pressurized to any pressure in the range(s) from about 0.01 psi gauge pressure to about 200 psi gauge pressure prior to a an outage sense time after the controller sensing the power outage condition to facilitate the fuel cell's start-up in a timeframe significantly faster than when there is no second reactant present and no pre-pressurization in the fuel cell prior to the optional controller sensing the power outage condition. Optionally, the one or more second reactants are present in the power source 102 at a time prior to an outage sense time, which outage sense time is in the range(s) from about 10 microseconds to about 10 seconds after the controller has sensed outage of primary power to the one or more loads system. Optionally, this time is also after the controller has sensed outage of primary power to the one or more loads.

Moreover, in this embodiment, one optional aspect provides that the volumes of one or both of the fuel storage unit 108 and the optional second reactant storage unit 110 can be independently changed as required to independently vary the energy of the system from its power, in view of the requirements of the system. Suitable such volumes can be calculated by utilizing, among other factors, the energy density of the system, the energy requirements of the one or more loads of the system, and the time requirements for the one or more loads of the system. In one embodiment, these volumes can vary in the range(s) from about 0.001 liters to about 1,000,000 liters.

In one aspect of this embodiment, at least one of, and optionally all of, the metal fuel cell(s) is a zinc fuel cell in which the fuel is in the form of fluid borne zinc particles immersed in a potassium hydroxide (KOH) electrolytic reaction solution, and the anodes within the cell cavities are particulate anodes formed of the zinc particles. In this embodiment, the reaction products can be the zincate ion, Zn(OH)₄²⁻, or zinc oxide, ZnO, and the one or more second reactants can be an oxidant (for example, oxygen (taken alone, or in any organic or aqueous (e.g., water-containing) fluid (for example and without limitation, liquid or gas (e.g., air)), hydrogen peroxide, and the like, and suitable combinations of any two or more thereof). When the second reactant is oxygen, the oxygen can be provided from the ambient air (in which case the optional second reactant storage unit 110 can be excluded), or from the second reactant storage unit 110. Similarly, when the second reactant is oxygen in water, the water can be provided from the second reactant storage unit 110, or from some other source, e.g., tap water (in which case the optional second reactant storage unit 110 can be excluded). In order to replenish the cathode, to deliver second reactant(s) to the cathodic area, and to facilitate ion exchange between the anodes and cathodes, a flow of the second reactant(s) can be maintained through a portion of the cells. This flow optionally can be maintained through one or more pumps (not shown in FIG. 1), blowers or the like, or through some other means.

In this embodiment, the particulate anodes are gradually consumed through electrochemical dissolution. In order to replenish the anodes, to deliver KOH to the anodes, and to facilitate ion exchange between the anodes and cathodes, a recirculating flow of the fuel borne zinc particles can be maintained through the cell cavities. This flow can be maintained through one or more pumps (not shown) or through some other means. As the potassium hydroxide contacts the zinc anodes, the following reaction takes place at the anodes:

Zn+4OH⁻→Zn(OH)₄²⁻+2e⁻ (1)

The two released electrons flow through a load to the cathode where the following reaction takes place:

$$\frac{1}{2} {O}_{2} + 2 {e}^{-} + {H}_{2} O \to 2 {OH}^{-} \qquad ( 2 )$$

The reaction product is the zincate ion, Zn(OH)₄²⁻, which is soluble in the reaction solution KOH. The overall reaction which occurs in the cell cavities is the combination of the two reactions (1) and (2). This combined reaction can be expressed as follows:

$$Zn + 2 {OH}^{-} + \frac{1}{2} {O}_{2} + {H}_{2} O \to {Zn ( OH )}_{4}^{2 -} \qquad ( 3 )$$

Alternatively, the zincate ion, Zn(OH)₄²⁻, can be allowed to precipitate to zinc oxide, ZnO, a second reaction product, in accordance with the following reaction:

Zn(OH)₄²⁻→ZnO+H₂O+2OH⁻ (4)

In this case, the overall reaction which occurs in the cell cavities is the combination of the three reactions (1), (2), and (4). This overall reaction can be expressed as follows:

$$Zn + \frac{1}{2} {O}_{2} \to ZnO \qquad ( 5 )$$

Under real world conditions, the reactions (4) or (5) yield an open-circuit voltage potential of about 1.4V. For additional information on this embodiment of a zinc/air battery, the reader is referred to U.S. Pat. Nos. 5,952,117; 6,153,328; 6,162,555; 6,296,958; 6,432,292; and 6,522,955; and U.S. patent application Ser. Nos. 09/930,557; 10/058,231; 10/066,544; and 10/085,477; each of which is hereby incorporated by reference herein as though set forth in full.

The reaction product Zn(OH)₄²⁻, and also possibly ZnO, can be provided to reaction product storage unit 104. Optional regeneration unit 106 can then reprocess these reaction products to yield oxygen, which can be released to the ambient air or stored in second reactant storage unit 110, and zinc particles, which are provided to fuel storage unit 108. In addition, the optional regeneration unit 106 can yield water, which can be discharged through a drain or stored in second reactant storage unit 110. It can also regenerate hydroxide, OH⁻, which can be discharged or combined with potassium to yield the potassium hydroxide reaction solution.

The regeneration of the zincate ion, Zn(OH)₄²⁻, into zinc, and one or more second reactants can occur according to the following overall reaction:

$${Zn ( OH )}_{4}^{2 -} \to Zn + 2 {OH}^{-} + {H}_{2} O + \frac{1}{2} {O}_{2} \qquad ( 6 )$$

The regeneration of zinc oxide, ZnO, into zinc, and one or more second reactants can occur according to the following overall reaction:

$$ZnO \to Zn + \frac{1}{2} {O}_{2} \qquad ( 7 )$$

It should be appreciated that embodiments of metal fuel cells other than zinc fuel cells or the particular form of zinc fuel cell described above are possible for use in a system according to the invention. For example, aluminum fuel cells, lithium fuel cells, magnesium fuel cells, iron fuel cells, and the like are possible, as are metal fuel cells where the fuel is not in particulate form but in another form such as sheets or ribbons or strings or slabs or plates. Embodiments are also possible in which the fuel is not fluid borne or continuously recirculated through the cell cavities (e.g., porous plates of fuel, ribbons of fuel being cycled past a reaction zone, and the like). It is also possible to avoid an electrolytic reaction solution altogether or at least employ reaction solutions besides potassium hydroxide, for example, without limitation, sodium hydroxide, inorganic alkalis, alkali or alkaline earth metal hydroxides. See, for example, U.S. Pat. No. 5,958,210, the entire contents of which are incorporated herein by this reference. It is also possible to employ metal fuel cells that output AC power rather than DC power using an inverter, a voltage converter, and the like.

Embodiments of Systems According to the Invention

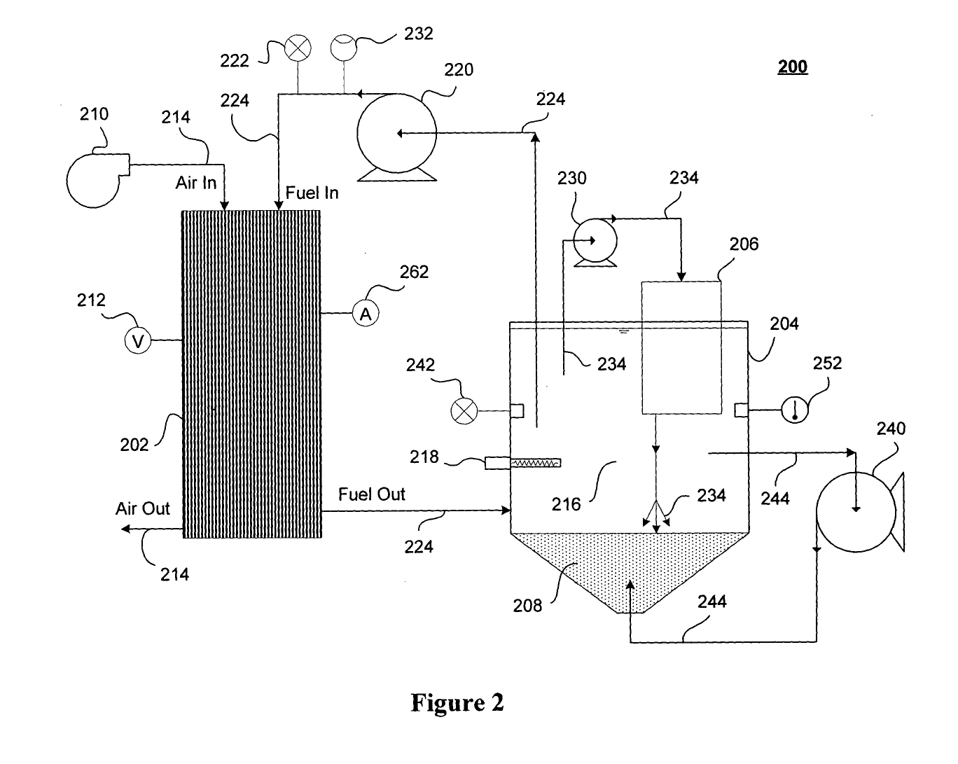

One particular embodiment of a metal particle fuel cell system configured for delivering power is depicted in FIG. 2. System 200 comprises a cell stack 202, a fuel storage tank 204, a regeneration unit 206, and a pump 220. Storage tank 204 contains an electrolyte solution 216, which may include fuel in the form of particles of an electroreducible metal such as zinc, and reaction products such as dissolved oxide forms of the metal, for example, ZnO dissolved in KOH. Pump 220 is configured to circulate solution 216 along flow path 224 from storage tank 204, into cell stack 202, and back into tank 204. Within cell stack 202, electrochemical reactions take place as described, for example, in equations 1 through 5. Oxygen from an oxygen source, such as ambient air, is blown along flow path 214 into and out of cell stack 202 by blower 210. The forced oxygen facilitates the chemical reactions, whereby a voltage potential is produced across cell stack 202. When system 200 is operating as described, the voltage across cell stack 202 may be coupled to a load for delivering power, thereby transitioning system 200 into a Discharge operating state. During Discharge, a fluidization pump 240 may also be turned on to circulate solution 216 along flow path 244 and into particle bed 208. The flow along path 244 causes an amount of fuel particles within particle bed 208 to disperse throughout tank 204 and become entrained within flow path 224, thereby delivering fuel to cell stack 202.

System 200 may also transition into a Regenerate state, which is an operating state wherein the fuel supply is replenished. After a substantial amount of solid fuel particles have been consumed in cell stack 202 and replaced by one or more reaction products, cell stack 202 will no longer be able to sustain a reaction to maintain a cell voltage within a desired range. A measurement of the fuel level in system 200 can therefore be derived by measuring the concentration of a reaction product such as potassium zincate in storage tank 204. Concentration sensor 242 is provided for this purpose. Sensor 242 may be any instrument capable of measuring a desired concentration, such as a conductivity sensor. When the fuel level falls below a desired minimum value, system 200 may enter into the Regenerate state. In the Regenerate state, blower 210 is shut down, pumps 220 and 240 are shut down, and regeneration pump 230 is started. Pump 230 circulates solution 216 along flow path 234 from storage tank 204, into electrolyzer 206, and back into tank 204. Electrolyzer 206 recovers solid fuel particles from spent electrolyte by growing new particles by means of electrolysis of the dissolved metal oxides. When particles grow to a desired size, they are harvested as regenerated fuel particles from electrolyzer 206. Harvesting may comprise removing the particles from a cathode (not shown) located within electrolyzer 206 by any suitable means such as scraping the cathode surface. After removal, the particles migrate from electrolyzer 206 along flow path 234 to compose particle bed 208, which lies at the bottom of tank 204, as shown. As fuel particles are recovered from solution 216, the concentration of the measured reaction product (e.g. potassium zincate) will decrease, and, as Regenerate continues, sensor 242 will eventually indicate a fuel level at or near a desired maximum value. At any point during Regenerate, when the fuel level is within a desired range, i.e. greater than a minimum desired level and less than the maximum, sufficient fuel exists for system 200 to reenter Discharge in the event of a power demand on cell stack 202.

System 200 may also transition into a Flush state, which is an operating state used to perform maintenance on cell stacks 202. System 200 transitions into Flush responsive to a “maintenance demand.” A maintenance demand may be invoked after prolonged operation of system 200 in a Discharge state, whereby solid oxides such as ZnO accumulate in the anode beds and inhibit the flow of solution 216. In order to clear the anode beds of these particles, cell stack 202 may be flushed with solution 216. For example, a zinc anode bed could be cleared of ZnO by flushing the anode bed with an electrolyte solution 216 including potassium zincate, provided that the electrolyte concentration is below the equilibrium saturation level. If so, the oxides will dissolve into the solution 216 and circulate back into storage tank 204. Thus, when system 200 transitions into a Flush state, pumps 230 and 240 are turned off, and pump 220 is turned on in order to circulate solution 216 along flow path 224. However, if a concentration of potassium zincate in solution 216 is not within a desired range, e.g. the concentration is not below the equilibrium saturation level, system 200 would be required to transition first into the Regenerate state, wherein the potassium zincate is converted to zinc metal. While in the Regenerate state, the potassium zincate concentration would reduce, eventually, to a level below equilibrium saturation, at which point system 200 could transition into the Flush state. Therefore, in one embodiment of the invention, sensing an electrolyte concentration within a desired range corresponding to a range below the equilibrium saturation level comprises a criteria for transitioning into Flush. One method of determining this criteria is by direct measurement of the electrolyte concentration in tank 204 using concentration sensor 242, the output of which, as previously described, comprises a measurement of the fuel level in system 200.

A low cell voltage across one or more cells comprising cell stack 202, measured during a Discharge state, may provide an indication that excessive oxide accumulation has occurred such that a maintenance demand is desirable. System 200 may be configured with one or more voltmeters 212 for this purpose. Alternatively, an indication invoking a maintenance demand may be derived from parameters other than cell voltage, such as an electrolyte concentration or temperature, as provided by temperature and concentration sensors 242 and 252, respectively. In another embodiment, a maintenance demand may be derived from a combination of the voltage measurement with measurements for electrolyte concentration, temperature, or other system 200 parameters. In yet another embodiment, a maintenance demand may be initiated periodically for good maintenance practice, for example, in response to any periodic control signal representing a maintenance demand.

System 200 may also transition into an Idle operating state. While system 200 is in the Idle state, blower 210 and pumps 220, 230, and 240 are shut down while a system controller (not shown) continuously monitors various parameters such as the presence of a maintenance demand signal (hereinafter “maintenance demand” or “Flush demand”), a power demand signal (hereinafter “power demand”), and a fuel level signal. The fuel level signal may indicate a low fuel level (e.g. a potassium zincate concentration measurement above an allowed maximum), a high fuel level (e.g. a potassium zincate concentration measurement below an allowed minimum), or a fuel level within a desired range (e.g. potassium zincate concentration between allowed maximum and minimum) sufficient to operate system 200 in the Discharge state for production of power at a desired level of cell voltage. In the Idle state, system 200 is enabled to enter into one of Flush, Regenerate, and Discharge states in response to sensing one or more of the parameters being monitored. In one embodiment, system 200 is configured with a heating means 218 which is energized while in Idle. Heating means 218 may be any means capable of delivering heat to solution 216, such as an electrical resistance heater in contact with tank 204, or immersed in solution 216. Heating means 218 maintains the temperature of solution 216 within a desired temperature range in order to facilitate operation of system 200 when transitioning from the Idle state into the Flush, Regenerate, or Discharge states. In one embodiment, heating means 218 maintains solution 216 between temperatures of about 25 degrees and about 55 degrees C.

System 200 may also transition into a Shutdown state, which is a non-operating state wherein all internal system components, i.e. blower 210, pumps 220, 230 and 240, heating means 218, etc. are powered off. Shutdown may be initiated manually, or it may be initiated as a safety precaution in response to sensing one or more abnormal values for system 200 parameters. These parameters may include, without limitation, cell stack 202 voltage, current, and temperature; and solution 216 flow, pressure, temperature, and concentration. Alternative embodiments of system 200 may be configured with one or more instruments, sensors, and/or transducers such as voltmeters 212, pressure sensors 222, flow meters 232, concentration sensors 242, temperature sensors 252, ammeters 262, and the like, as necessary for sensing abnormal system conditions.

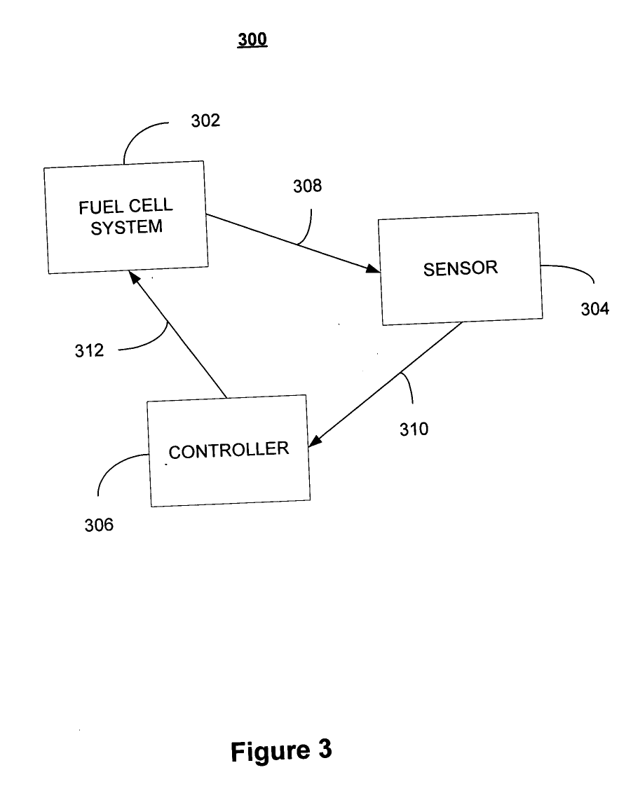

FIG. 3 is a block diagram of an embodiment of a self-controlling fuel cell power system 300 according to the invention. In FIG. 3, and in subsequently disclosed embodiments, fuel cell systems that have been previously denoted as a “system”, such as system 100 and system 200, are hereinafter denoted as fuel cell “subsystem” as shown in block 302. In this simplified embodiment, fuel cell subsystem 302 comprises one or more fuel cells capable of operating in a plurality of operating states. Sensor 304 is configured to sense one or more parameters 308 of subsystem 302, and transmits a value 310 representing parameter 308 to a controller 306. A parameter 308 may be any measurable physical quantity such as a temperature, concentration, voltage, etc. Additionally, a parameter 308 may represent a control signal such as a maintenance demand, a power demand, or a shutdown signal, based exclusively or in part on the measured parameter 308. Sensor 304 may represent any of the various aforementioned instruments used as a means for sensing or transducing a parameter described in system 200. Controller 306 is configured to transition fuel cell subsystem 302 to a selected one of the operating states responsive to the value 310, and hence, the sensed parameter 308, by means of one or more control/relay signals 312. Controller 306 may be any device capable of transmitting control signals to internal components of fuel cell subsystem 302, such as a microprocessor or a system of relays. A control/relay signal 312 represents a command, such as a maintenance demand, a power demand, or an on/off signal for actuating a component of fuel cell subsystem 302.

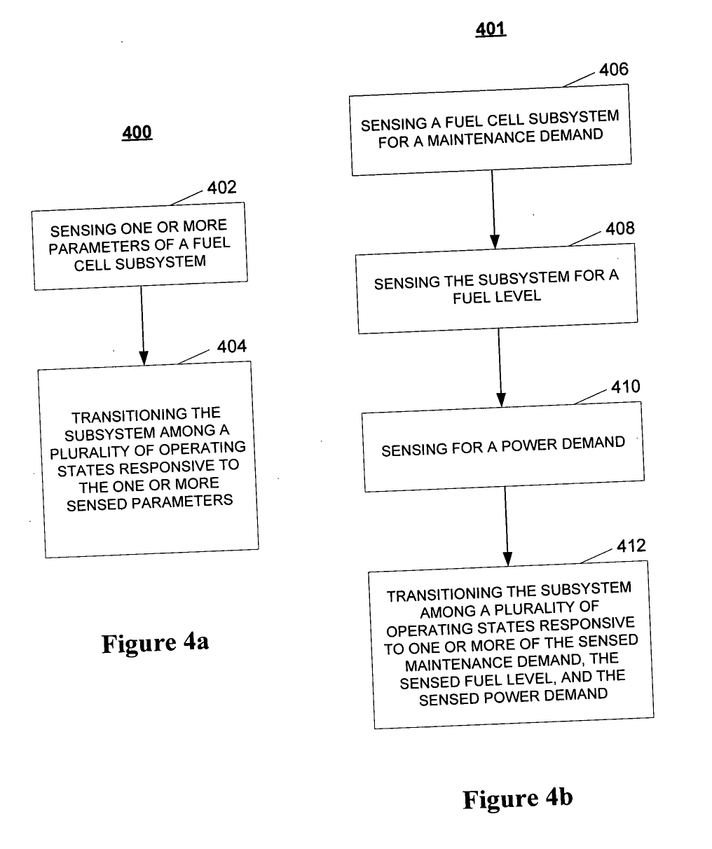

FIG. 4a illustrates one embodiment of a method 400 for operating a self-controlling fuel cell power system according to the invention. In step 402, one or more parameters of a fuel cell subsystem are sensed by appropriate sensing means. Sensed parameters include, without limitation, one or more physical parameters of a fuel cell subsystem. In step 404, the fuel cell subsystem is transitioned among a plurality of operating states responsive to the one or more sensed parameters. The states may include, for example, the Idle, Discharge, Flush, and Regenerate states previously discussed.

FIG. 4b illustrates another embodiment of a method 401 for operating a self-controlling fuel cell power system according to the invention. In step 406, the method senses a fuel cell subsystem for a maintenance demand. This sensing step may comprise sensing for one or more physical parameters of the fuel cell subsystem. In step 408, the method senses the subsystem for a fuel level, which, as in the embodiment of system 200, may comprise a physical parameter such as an electrolyte concentration. In step 410, the method senses for a power demand. The power demand being sensed for may originate as a signal outside the subsystem, for example, a signal indicating that a primary power source, for which the fuel cell subsystem provides backup, has gone off line. Other examples may include periodic demand signals, for example, a demand for power to provide outdoor lighting at night, or any other parameter indicative of a load demanding power from the fuel cell subsystem. Lastly, in step 412, the method transitions the subsystem among a plurality of operating states responsive to one or more of the sensed maintenance demand, fuel level, and power demand parameters.

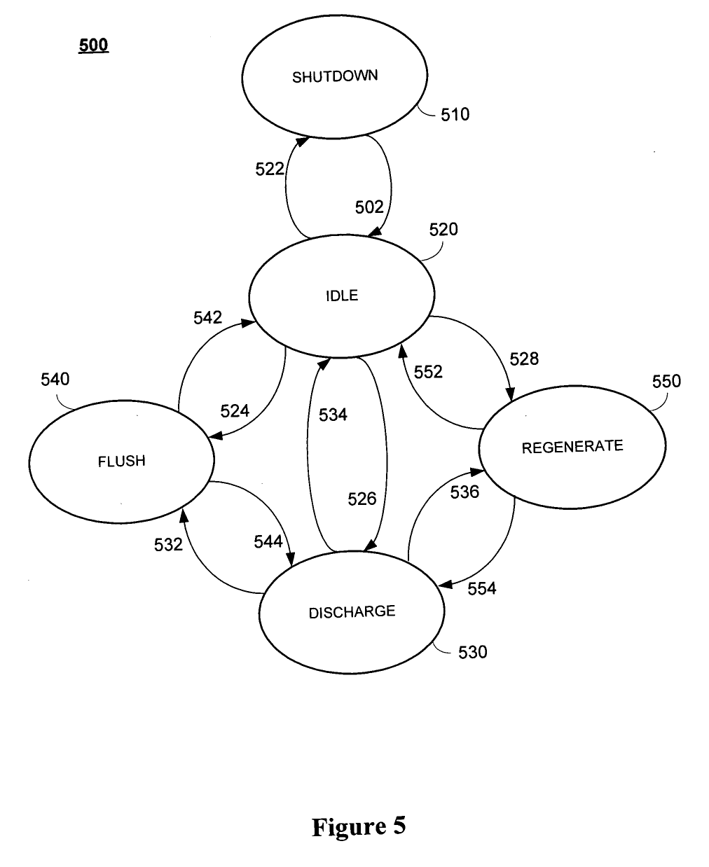

The plurality of operating states to which a fuel cell subsystem may transition in accordance with the invention, may be better understood with reference to the state diagram shown in FIG. 5. As illustrated, the subsystem 500 may transition among operating states Shutdown 510, Idle 520, Discharge 530, Flush 540, and Regenerate 550, by means of the various numerically labeled transition paths. Each numerical transition path represents one or more control signals from a controller, which signals may be sensed demand signals and/or sensed subsystem 500 parameters. For example, subsystem 500 may transition from Shutdown 510 to Idle 520 along path 502 representing a demand for a manual start; or from Idle 520 to Shutdown 510 along path 522 representing a sensed abnormal value for a subsystem 500 parameter. In another implementation, subsystem 500 may transition from Idle 520 to Flush 540 along path 524 representing a periodic maintenance demand; or from Flush 540 to Idle 520 along path 542 representing a power demand. In another implementation, subsystem 500 may transition from Discharge 530 to Flush 540 along path 532 representing a low fuel level; or from Flush 540 to Discharge 530 along path 544 representing a power demand. In another implementation, subsystem 500 may transition from Idle 520 to Regenerate 550 along path 528 representing a low fuel level; or from Regenerate 550 to Idle 520 along path 552 representing a high (or full) fuel level. In other implementations, subsystem 500 may transition from Idle 520 to Discharge 530 along path 526, or from Regenerate 550 to Discharge 530 along path 554, paths 526 and 524 representing power demands. Similarly, transitions from Discharge 530 to Idle 520, and Discharge 530 to Regenerate 550 are possible along paths 534 and 536, respectively, representing some other sensed parameter or demand. Still other implementations are possible in which a single sensed parameter or demand may cause a transition from one state to another state via a third state. For example, an implementation of the invention may require a transition from Discharge 530 to Flush 540 to be accomplished through an intermediate transition to Regenerate 550 in order to first establish a concentration of an electrolyte below an equilibrium saturation level.

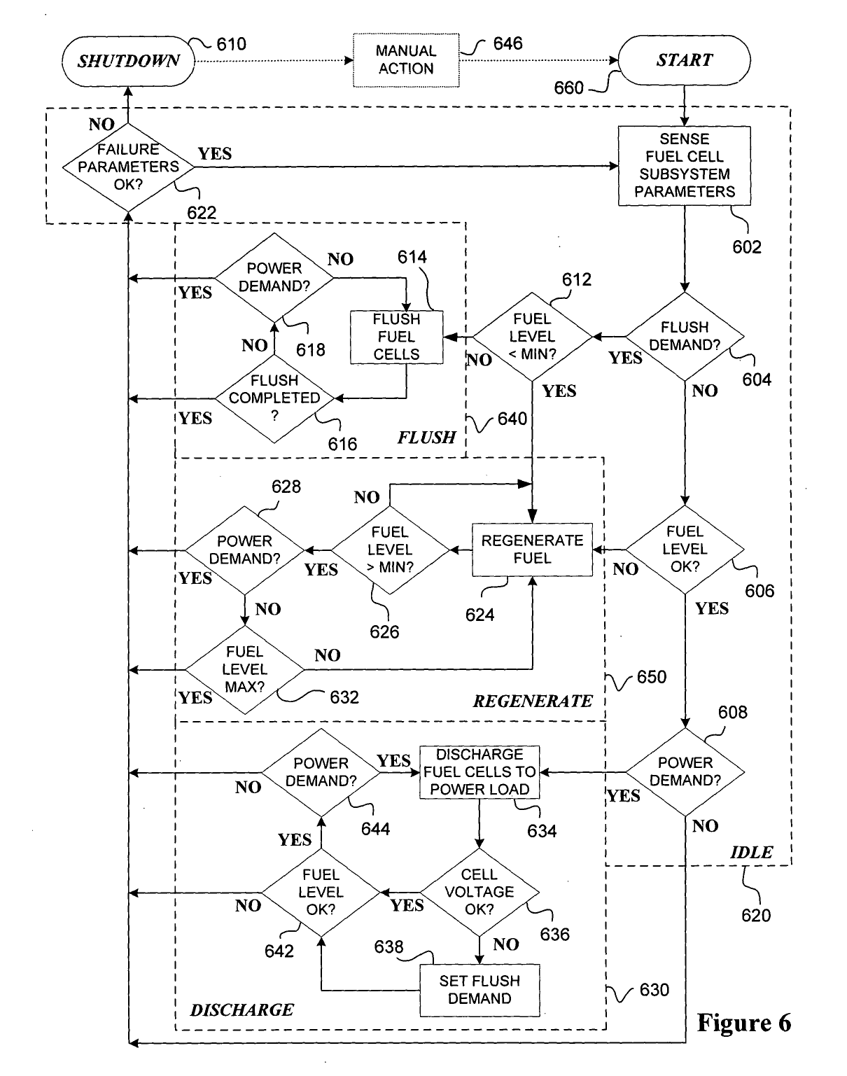

FIG. 6 is a process flow diagram illustrating one embodiment of a method according to the invention for operating a self-controlling fuel cell power system. The process of FIG. 6 may be applied, for example, as a series of functions performed by a controller as in FIG. 3 to transition a fuel cell subsystem as in FIG. 2 among a plurality of operating states as in FIG. 6. Beginning at Start block 660, the process initializes by transitioning a fuel cell subsystem into an Idle state 620. Idle state 620 comprises process block 602, and decision blocks 604, 606, 608, 612, and 622. In block 602, the process senses for fuel cell subsystem parameters, which in effect, is equivalent to executing decision blocks 604, 606, 608, 612, and 622. The first such block is decision block 604, in which the process senses for a maintenance, or “Flush” demand. If a Flush demand is present, for example, as a result of a periodic signal or as a result of sensing a low cell voltage, then the process proceeds to step 612. In decision block 612, the process senses for a subsystem fuel level, which level may comprise an electrolyte concentration level. If the fuel level is greater than a desired minimum, the fuel cell subsystem transitions to a Regenerate state. However, if the fuel level is less than a desired minimum, the process transitions to a Flush state 640, beginning with step 614.

Flush state 640 comprises blocks 614, 616, and 618. In step 614, the flushing process is initiated wherein an electrolyte solution having a concentration below an equilibrium saturation level is circulated through the fuel cells of the fuel cell subsystem. As long as the fuel cell subsystem operates in Flush 640, the process periodically executes decision block 616, sensing for an indication that the flushing process has been completed. This indication may comprise, without limitation, another fuel level indication, or an indication that sufficient time has elapsed since entering into Flush 640. If flushing is complete, the Flush demand is reset, and the process transitions from Flush 640 to block 622 of Idle 620. However, if flushing is not complete, decision block 618 is executed by sensing for a power demand. If no power demand is present, flushing continues; however, if a power demand is present, the fuel cell subsystem transitions to block 622 of Idle 620.

In one embodiment, a fuel cell subsystem controlled according to FIG. 6 can transition to the Regenerate state 650 from the Idle state 620 through either fuel level sensor decision block 606 or 612. From either block, a fuel level signal indicating a fuel level below a desired minimum level will cause the subsystem to begin to regenerate spent fuel as shown in process block 624. As long as the subsystem operates in the Regenerate state 650, periodic fuel level sensing will occur, as in decision block 626. If the fuel level remains below a desired range, the process remains at block 624, and the fuel regeneration process continues. However, if the sensed fuel level is greater than a desired minimum, the process proceeds to step 628. Block 628 is another power demand query, which, if power demand is present, transitions the subsystem from the Regenerate state 650 to the Idle state 620. If there is no power demand, a fuel level is sensed in step 632. If the sensed fuel level in block 632 indicates a level at or near to a desired maximum, the subsystem transitions back to block 622 of Idle 620; otherwise, the subsystem remains in the Regenerate state 650, proceeding back to process block 624.

Returning to decision block 606 in the Idle state 620, if a sensed fuel level is within a desired fuel level range, decision block 608 is performed. Block 608 senses for a power demand; if there is no power demand, the subsystem remains in the Idle state 620 and proceeds to block 622. However, if there is a power demand, the subsystem transitions to process block 634 in the Discharge state 630. Block 634 initiates a discharge cycle wherein the appropriate pumps and blowers are turned on to circulate electrolyte and air into the cell stack of the subsystem in order to develop a voltage and thence deliver power to meet the demand. Periodically while in the Discharge state 630, decision block 636 will be executed to sense for one or more voltages in the cell stack. If a sensed voltage is below a desired range, process block 638 sets a Flush demand which will cause the subsystem to transition from the Idle state 620 to the Flush state 640 by execution of decision block 604 when the subsystem is next operating in the Idle state 620. After setting a Flush demand in block 638, or if no voltages sensed during execution of block 636 are below a desired range, the process proceeds to decision block 642. Block 642 is another sensing step for fuel level; if the sensed fuel level is below a desired fuel level range, the subsystem transitions from the Discharge state 630 to decision block 622 of the Idle state 620. If the fuel level sensed in block 642 is within a desired fuel level range, the process proceeds to decision block 644, which executes another sensing for a power demand. If a power demand is still present, the process loops back to block 634 and the subsystem continues to operate in the Discharge state 630 to meet the demand. However, if the power demand is no longer present, the subsystem transitions from the Discharge state 630 to decision block 622 in the Idle state 620.

Decision block 622 comprises a diagnostic check whereby various parameters of the fuel cell subsystem are sensed for any indication of an abnormal condition which may lead to catastrophic failure of the subsystem or some other unsafe or undesired event. Parameters sensed during execution of block 622 include, without limitation, cell stack voltage, current, and temperature; and electrolyte solution flow, pressure, temperature, and concentration. If an abnormal condition is sensed, block 622 may cause the subsystem to immediately transition to the nonoperating Shutdown state 610. In one embodiment, subsystem operation may be restored by manual action 646 to initiate the control process beginning with Start block 660. If, in block 622, no abnormal conditions are sensed, the subsystem remains in Idle 620 and the process proceeds back to the initial process block 602. It should be noted that if, upon transitioning into the Idle state 620 at block 622, one or more of a power demand, a Flush demand, or a low fuel level condition is already present, the process will transition without delay to the most appropriate operating state through sequential execution of decision blocks 604, 606, and 608. Thus, in the embodiment of FIG. 6, the Idle state 620 serves as an intermediate operating state for a transition between any two of the Discharge 630, Flush 640, and Regenerate 650 states. Skilled artisans will appreciate that other embodiments of the invention are possible in which state-to-state transitions may occur without the need for intermediate operation in an Idle, or other, state. Moreover, other embodiments are possible in which the various operating states may comprise additional sensing and processing steps.

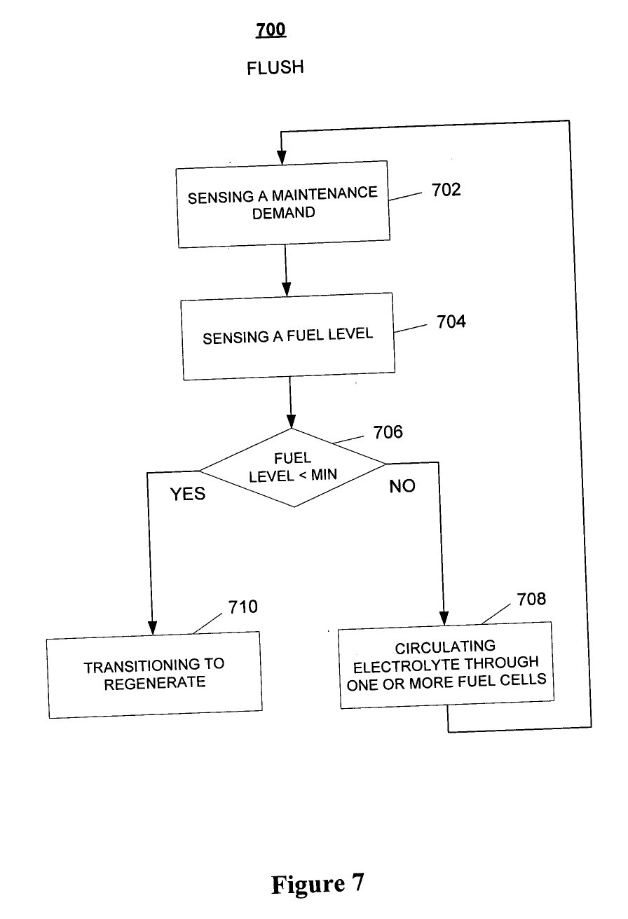

FIG. 7 illustrates an embodiment of a method 700 according to the invention for a self-controlling fuel cell power system to operate a fuel cell subsystem in a Flush state. Method 700 begins with step 702 which comprises sensing for a maintenance demand. As in previous embodiments, the sensing may be accomplished by one or more sensors within the power system. If a maintenance demand is present, the method proceeds to step 704. In step 704, a fuel level is sensed by any of the means previously discussed, and in step 706, the sensed fuel level is compared to a desired minimum fuel level. If the sensed fuel level is below the desired minimum level, step 710 is performed in which case the fuel cell subsystem is transitioned to a Regenerate state. If, however the sensed fuel level is not below the minimum level, step 708 is performed. In step 708, electrolyte is circulated through one or more fuel cells. The method then loops back to the initial step 702, and the process continues until the maintenance demand is no longer present, or unless a low fuel level is subsequently sensed in a step 704.

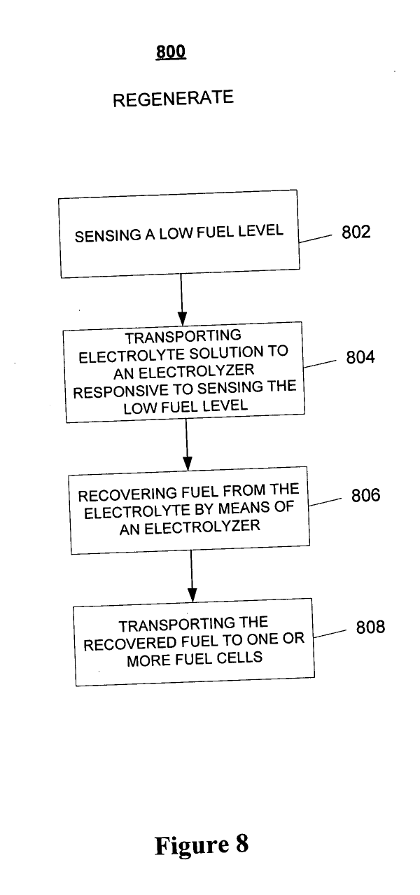

FIG. 8 illustrates an embodiment of a method 800 according to the invention for a self-controlling fuel cell power system to operate a fuel cell subsystem in a Regenerate state. This method begins with a sensing step 802 in which a fuel level is sensed by one or more sensors within the fuel cell power system. Sensing a fuel level in a fuel cell subsystem may comprise directly sensing a quantity of expendable fuel, or, as disclosed above, may comprise a sensing a concentration level of a reaction product in an electrolyte. In the next step 804, an electrolyte solution containing spent fuel products is transported to an electrolyzer in response to sensing a fuel level below a desired fuel level range. The next step 806 comprises recovering fuel from the electrolyte by means of an electrolyzer. In one embodiment, fuel is recovered in the form of metal particles grown within the electrolyzer by electrolysis onto a cathode surface. When the recovered fuel particles have grown to a sufficient size, they are transported in the final step 808 back to one or more fuel cells of the fuel cell subsystem.

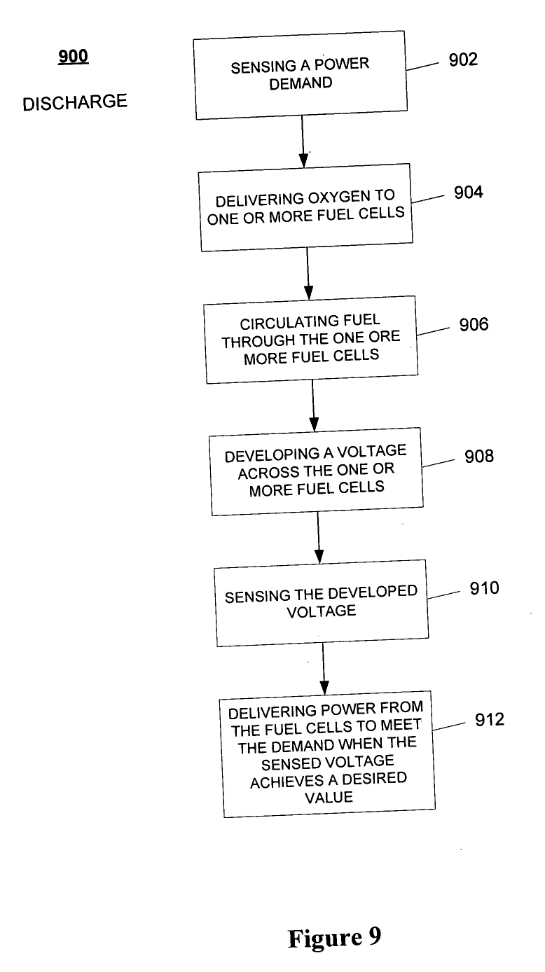

FIG. 9 illustrates an embodiment of a method 900 according to the invention for a self-controlling fuel cell power system to operate a fuel cell subsystem in a Discharge state. This method also begins with a sensing step 902, in which a power demand parameter is sensed for by one or more sensors of the power system. In the next step 904, oxygen is delivered to one or more fuel cells of the fuel cell subsystem by any known means, such as by activation of an air blower, or by simply allowing an ambient air flow through the cell stack by convection. Next, in step 906, fuel is circulated through the one or more fuel cells, for example, in the form of metal particles entrained in a flow of electrolyte. In step 908, the one or more fuel cells develop a voltage by chemical reaction of the fuel with oxygen and/or additional reactants present in the electrolyte. Step 910 is another sensing step in which one or more power system sensors sense the voltage developed across the one or more fuel cells. Finally, in step 912, the power system delivers power from the fuel cell subsystem to meet the power demand when the sensed voltage, or voltages, achieve a desired value.

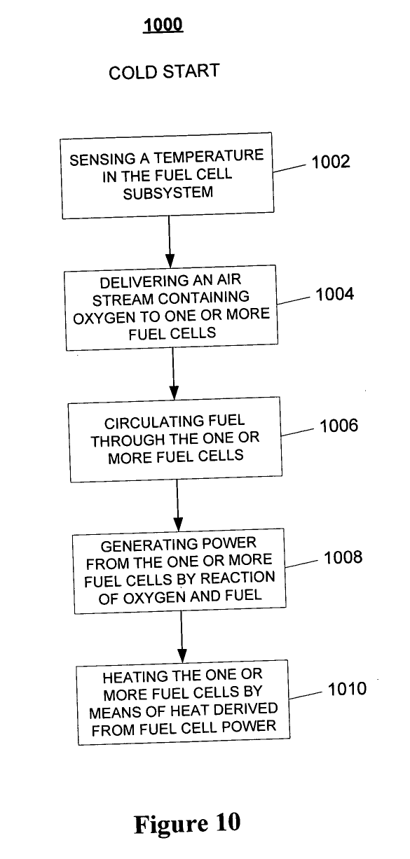

FIG. 10 illustrates an embodiment of a method 1000 for a self-controlling fuel cell power system to operate a fuel cell subsystem in a Discharge state during an initial cold-start period. A cold-start period is a transient period during which chemical reactions in the one or more fuel cells are slow to develop power, due to an initially low temperature of one or more fuel cell cathodes. When a power demand occurs during an initial low temperature condition wherein the cathode temperatures are below a steady-state temperature range, the fuel cell subsystem may require a form of pre-heating to accelerate the development of adequate power. Method 1000 is one embodiment of a cold-start method for a fuel cell subsystem in the Discharge state. In the initial step 1002, a cold-start condition is sensed by sensing a temperature in the fuel cell subsystem. Any temperature below a desired cold-start range, such as an ambient temperature, may indicate a cold-start condition. Next, in step 1004, an oxygen source such as an air stream is delivered to one or more fuel cells, and in step 1006, fuel is circulated through the one or more fuel cells. In step 1008, power is generated in the fuel cells as a result of reactions therein of the oxygen and fuel. In the final step 1010, the fuel cells are heated by means of heat derived from the power generated in the previous step. The heating means may be passage of an electrical current, such as through energization of an electrical resistance heater, or may be any other means suitable for the purpose. In one embodiment, the heating means is a heater immersed within an electrolyte solution being transported to the fuel cells. In another embodiment, a heater is placed within the air stream to pre-heat oxygen entering the fuel cells. In yet another embodiment, the heating means may pass an electrical current directly through the conductive surface of one or more cathodes within the one or more fuel cells. In other embodiments, heat may be transferred from other locations within the fuel cell subsystem, provided that ultimately, heat transfer to the cathode surfaces occurs.

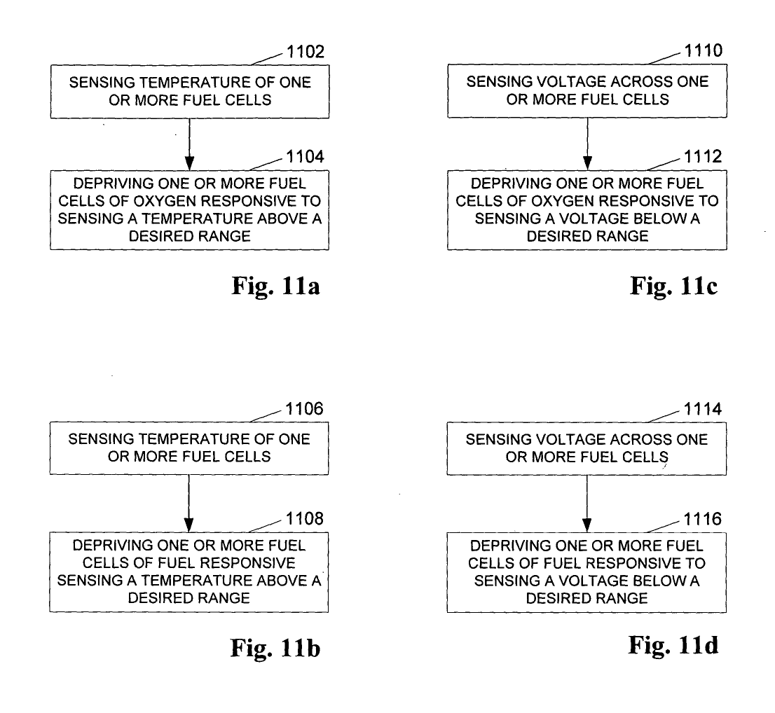

FIGS. 11a-11d illustrate embodiments of methods according to the invention for a self-controlling fuel cell power system to reduce shorting currents in a fuel cell subsystem in a Discharge state. Each of the embodiments illustrated in FIGS. 11a-11d represent a method for shutting down the reactions that produce power within a fuel cell subsystem in response to sensing an abnormal operating parameter indicative of a fault current through one or more fuel cells in the fuel cell subsystem. Such parameters include, without limitation, temperatures in one or more fuel cells above a normal operating range, and cell voltages developed across one or more fuel cells below a normal operating range. Generally, the methods in FIGS. 11a-11d comprise sensing an abnormal parameter value in one or more fuel cells, and in response to sensing the value, depriving one or more fuel cells of a reactant, such as fuel or oxygen, necessary to sustain a chemical reaction in a cell. A fuel cell may be deprived of one or more reactants by various means, such as shutting down an air blower providing oxygen, shutting down a pump supplying fuel, or draining a fuel cell cavity of electrolyte. In a first embodiment of FIG. 11a, in step 1102 a temperature is sensed in one or more of the fuel cells. Next, in step 1104, the fuel cells are deprived of oxygen responsive to sensing a temperature above a desired range. In a second embodiment of FIG. 11b, in step 1106 a temperature is sensed in one or more of the fuel cells, and in step 1108, the fuel cells are deprived of fuel responsive to sensing a temperature above a desired range. In a third embodiment of FIG. 11c, in step 1110 a voltage is sensed across one or more of the fuel cells, and in step 1112, the fuel cells are deprived of oxygen responsive to sensing a voltage above a desired range. Finally, in an embodiment depicted in FIG. 11d, in step 1114 a voltage is sensed across one or more of the fuel cells, and in step 1116, the fuel cells are deprived of fuel responsive to sensing a voltage above a desired range.

While various embodiments of the invention have been described, it will be apparent to those of ordinary skill in the art that many more embodiments and implementations are possible that are within the scope of this invention. Accordingly, the invention is not to be restricted except in light of the attached claims and their equivalents.

What is claimed is:

1. A self-controlling fuel cell power system, comprising:
a fuel cell subsystem having one or more fuel cells and a plurality of operating states;
one or more sensors configured to sense one or more parameters of the fuel cell subsystem; and
a controller configured to transition the fuel cell subsystem among the operating states responsive to the one or more sensed parameters.

2. The system of claim 1 wherein the operating states include a Discharge state wherein the one or more fuel cells expend fuel to deliver power.

3. The system of claim 2 wherein the operating states include a Regenerate state wherein the fuel cell subsystem converts expended fuel into reusable fuel.

4. The system of claim 3 wherein the operating states include a Flush state wherein the one or more fuel cells are reconditioned.

5. The system of claim 4 wherein the fuel cell parameters include a fuel level, a cell voltage developed by one or more of the fuel cells, and a power demand from a load.

6. The system of claim 5 wherein the operating states include an Idle state, and wherein the controller maintains the fuel cell subsystem in Idle responsive to sensing the fuel level within a desired level range, sensing no maintenance demand, and sensing no power demand from the load.

7. The system of claim 6 wherein the controller transitions the fuel cell subsystem between the Idle and Regenerate states responsive to sensing the fuel level below the desired level range while operating in the Idle state.

8. The system of claim 6 wherein the controller transitions the fuel cell subsystem between the Idle and Discharge states responsive to sensing the power demand while operating in the Idle state.

9. The system of claim 6 wherein the controller transitions the fuel cell subsystem between the Idle and Flush states responsive to a maintenance demand while operating in the Idle state.

10. The system of claim 6 wherein the controller transitions the fuel cell subsystem between the Regenerate and Idle states responsive to sensing the power demand while operating in the Regenerate state.

11. The system of claim 6 wherein the controller transitions the fuel cell subsystem between the Regenerate and Idle states responsive to sensing the fuel level within the desired level range while operating in the Regenerate state.

12. The system of claim 6 wherein the controller transitions the fuel cell subsystem between the Discharge and Flush states responsive to sensing no power demand while operating in the Discharge state.

13. The system of claim 6 wherein the controller transitions the fuel cell subsystem between the Discharge and Flush states responsive to sensing the fuel level below the desired level range while operating in the Discharge state.

14. The system of claim 6 wherein the controller transitions the fuel cell subsystem between the Flush and Idle states responsive to sensing the power demand while operating in the Flush state.

15. The system of claim 6 wherein the controller transitions the fuel cell subsystem between the Flush and Idle states responsive to sensing no maintenance demand while operating in the Flush state.

16. The system of claim 1 wherein the fuel cell subsystem has a non-operating Shutdown state, and wherein the controller may transition the fuel cell subsystem from at least one of the operating states to the Shutdown state responsive to sensing one or more of the parameters outside of a desired range.

17. The system of claim 16 wherein the controller may transition the fuel cell system from at least one of the operating states to the Shutdown state responsive to a manual control signal.

18. The system of claim 16 wherein one of the sensed parameters is a fuel cell temperature.

19. The system of claim 16 wherein one of the sensed parameters is the cell voltage.

20. The system of claim 16 wherein the fuel cell subsystem further comprises one or more reactants contained in the fuel cells, and wherein the fuel cells are deprived of at least one of the reactants during the Shutdown state.

21. A self-controlling fuel cell power system, comprising:
a fuel cell subsystem comprising:
a plurality of operating states;
one or more fuel cells for developing power; and
a heating means for heating the one or more fuel cells;
one or more sensors configured to sense one or more parameters of the fuel cell subsystem; and
a controller configured to transition the fuel cell subsystem to a selected one of the operating states responsive to the one or more sensed parameters, wherein the operating states include a Discharge state wherein the heating means may be energized by the power developed by the fuel cells.

22. The system of claim 21 wherein the heating means comprises an electrical resistance heater.

23. The system of claim 22 wherein the one or more fuel cells develop power by expending fuel, and wherein the heater delivers heat to the fuel.

24. The system of claim 23 wherein the one or more fuel cells develop power by chemical reaction of the fuel and oxygen, and wherein the heater delivers heat to the oxygen.

25. The system of claim 22 wherein the heater delivers heat to one or more electrodes of the one or more fuel cells.

26. The system of claim 25 wherein the one or more electrodes comprise cathodes.

27. A method of operating a self-controlling fuel cell power system, comprising:
sensing one or more parameters of a fuel cell subsystem; and
transitioning the fuel cell subsystem among a plurality of operating states responsive to the one or more sensed parameters.

28. The method of claim 27 wherein the sensing step further comprises sensing a maintenance demand, and wherein the transitioning step further comprises transitioning the fuel cell subsystem into a Flush state responsive to sensing the maintenance demand.

29. The method of claim 28 wherein the sensing step further comprises sensing a power demand, and wherein the transitioning step further comprises transitioning the fuel cell subsystem into a Discharge state responsive to sensing the power demand.

30. The method of claim 29 wherein the sensing step further comprises sensing a fuel level, and wherein the transitioning step further comprises transitioning the fuel cell subsystem into a Regenerate state responsive to sensing the fuel level below a desired range.

31. The method of claim 30 wherein the operating states include an Idle state, and wherein the transitioning step further comprises transitioning the fuel cell subsystem into an Idle state responsive to sensing no maintenance demand, sensing no power demand, and sensing the fuel level within a desired level range.

32. The method of claim 31 further comprising transitioning the fuel cell subsystem between the Idle and Regenerate states responsive to sensing the fuel level below the desired level range while operating in the Idle state.

33. The method of claim 31 further comprising transitioning the fuel cell subsystem between the Idle and Discharge states responsive to sensing the power demand while operating in the Idle state.

34. The method of claim 31 further comprising transitioning the fuel cell subsystem between the Idle and Flush states responsive to sensing the maintenance demand while operating in the Idle state.

35. The method of claim 31 further comprising transitioning the fuel cell subsystem between the Regenerate and Idle states responsive to sensing the power demand while operating in the Regenerate state.

36. The method of claim 31 further comprising transitioning the fuel cell subsystem between the Regenerate and Idle states responsive to sensing the fuel level within the desired level range while operating in the Regenerate state.

37. The method of claim 31 further comprising transitioning the fuel cell subsystem between the Discharge and Flush states responsive to sensing no power demand while operating in the Discharge state.

38. The method of claim 31 further comprising transitioning the fuel cell subsystem between the Discharge and Flush states responsive to sensing the fuel level below the desired level range while operating in the Discharge state.

39. The method of claim 31 further comprising transitioning the fuel cell subsystem between the Flush and Idle states responsive to sensing the power demand while operating in the Flush state.

40. The method of claim 31 further comprising transitioning the fuel cell subsystem between the Flush and Idle states responsive to sensing no maintenance demand while operating in the Flush state.

41. The method of claim 31 further comprising transitioning the fuel cell subsystem to a non-operating Shutdown state responsive to sensing one or more of the parameters outside of a desired range.

42. The method of claim 41 wherein the one or more parameters is a temperature in the fuel cell subsystem.

43. The method of claim 41 wherein the one or more parameters is a voltage in the fuel cell subsystem.

44. The method of claim 41 wherein the one or more parameters is an electrical current in the fuel cell subsystem.

45. The method of claim 41 wherein the one or more parameters is a pressure in the fuel cell subsystem.

46. The method of claim 41 wherein the one or more parameters is a fluid flow in the fuel cell subsystem.

47. The method of claim 41 further comprising transitioning the fuel cell system from at least one of the operating states to the Shutdown state responsive to a manual control signal.

48. The method of claim 41 further comprising transitioning the fuel cell subsystem into the Shutdown state by depriving fuel cells of one or more reactants.

49. A method of operating a self-controlling fuel cell power system to transition a fuel cell subsystem among a plurality of operating states, the subsystem having one or more fuel cells, the method comprising:
sensing for a maintenance demand;
sensing for a fuel level;
sensing for a power demand;
operating the fuel cell subsystem in an Idle operating state responsive to sensing no maintenance demand, sensing a fuel level within a desired level range, and sensing no power demand;
transitioning the fuel cell subsystem from the Idle state to a Flush operating state, and operating the subsystem in a Flush state, responsive to sensing the maintenance demand while operating in the Idle state;
transitioning the operating state from the Idle state to a Discharge operating state, and operating the subsystem in the Discharge state, responsive to sensing the power demand while operating in the Idle state;
transitioning the operating state from the Idle state to a Regenerate operating state, and operating the subsystem in the Regenerate state, responsive to sensing the fuel level outside a desired level range while operating in the Idle state.

50. The method of claim 49 further comprising transitioning between the Idle and Flush states responsive to sensing a cell voltage outside a desired range while operating in the Discharge state.

51. The method of claim 49 further comprising transitioning between the Regenerate and Idle states responsive to sensing a power demand while operating in the Regenerate state.

52. The method of claim 49 further comprising transitioning between the Discharge and Flush states responsive to sensing the fuel level outside a desired level range while operating in the Discharge state.

53. The method of claim 49 further comprising transitioning between the Flush and Idle states responsive to sensing no maintenance demand while operating in the Flush state.

54. The method of claim 49 wherein operating the fuel cell subsystem in the Flush state further comprises:
sensing an electrolyte concentration; and
if the concentration is below a desired level, circulating the electrolyte through the one or more fuel cells;
if the concentration is above the desired level, transitioning the fuel cell subsystem to the Regenerate state.

55. The method of claim 49 wherein operating the fuel cell subsystem in the Regenerate state further comprises:
transporting electrolyte solution to an electrolyzer responsive to sensing a fuel level below a desired range;
recovering fuel from the electrolyte solution by means of the electrolyzer; and
transporting the recovered fuel to the one or more fuel cells.

56. The method of claim 55 further comprising maintaining the electrolyte within a desired temperature range while operating the system in the Regenerate state.

57. The method of claim 56 wherein the temperature range is between about 25 degrees and about 55 degrees C.

58. The method of claim 49 wherein operating the fuel cell subsystem in the Discharge state further comprises:
delivering oxygen to the one or more fuel cells;
circulating fuel through the one or more fuel cells;
developing a voltage across the one or more fuel cells by reaction of oxygen and fuel;
sensing the developed voltage; and
delivering power from the one or more fuel cells to meet the demand when the sensed voltage achieves a value within a desired range.

59. The method of claim 58 further comprising maintaining the one or more fuel cells within a desired temperature range while operating the system in the Discharge state.

60. The method of claim 59 wherein the temperature range is between about 25 degrees and about 55 degrees C.

61. The method of claim 49 wherein operating the system in the Discharge state further comprises:
delivering an air stream containing oxygen to the one or more fuel cells;
circulating fuel through the one or more fuel cells;
generating power from the one or more fuel cells by reaction of oxygen and fuel; and
heating the one or more fuel cells by means of a heat derived from the power, thereby facilitating the reaction.

62. The method of claim 61 wherein the heating means comprises an electrical resistance heater.

63. The method of claim 62 wherein the heater delivers heat to the circulating fuel.

64. The method of claim 62 wherein the heater delivers heat to the air stream.

65. The method of claim 62 wherein the heater delivers heat to one or more fuel cell electrodes.

66. The method of claim 65 wherein the one or more electrodes comprise one or more cathodes.

67. The method of claim 58 wherein operating the system in the Discharge state further comprises:
sensing temperature of the one or more fuel cells; and
depriving the one or more fuel cells of one or more reactants responsive to sensing a temperature above a desired range.

68. The method of claim 67 wherein the depriving step comprises depriving the one or more fuel cells of oxygen.

69. The method of claim 67 wherein the depriving step comprises depriving the one or more fuel cells of fuel.

70. The method of claim 58 wherein operating the system in the Discharge state further comprises:
sensing voltage developed by one or more fuel cells; and
depriving the one or more fuel cells of one or more reactants responsive to sensing a voltage below a desired range.

71. The method of claim 70 wherein the depriving step comprises stopping the delivery of oxygen.

72. The method of claim 70 wherein the depriving step comprises stopping the circulation of fuel.
